(19) United States
(12) Patent Application Publication
(10) Pub. No.: US 2025/0077261 A1
(43) Pub. Date: Mar. 6, 2025

(54) METHOD AND APPARATUS FOR IMPROVING HYPERVISOR PERFORMANCE IN MEMORY DISAGGREGATION ENVIRONMENT

(71) Applicants: ELECTRONICS AND TELECOMMUNICATIONS RESEARCH INSTITUTE, Daejeon (KR); AJOU UNIVERSITY INDUSTRY-ACADEMIC COOPERATION FOUNDATION, Suwon-si (KR)

(72) Inventors: Tae-Hoon KIM, Daejeon (KR); Kwang-Won KOH, Daejeon (KR); Chang-Dae KIM, Daejeon (KR); Eun-Ji PAK, Daejeon (KR); Yeon-Jeong JEONG, Daejeon (KR); Sang-Hoon KIM, Suwon-si (KR)

(73) Assignees: ELECTRONICS AND TELECOMMUNICATIONS RESEARCH INSTITUTE, Daejeon (KR); AJOU UNIVERSITY INDUSTRY-ACADEMIC COOPERATION FOUNDATION, Suwon-si (KR)

(21) Appl. No.: 18/746,307

(22) Filed: Jun. 18, 2024

(30) Foreign Application Priority Data
Sep. 5, 2023 (KR) 10-2023-0117380
Nov. 23, 2023 (KR) 10-2023-0164357

(51) Int. Cl. G06F 9/455; G06F 3/06

(52) U.S. Cl. CPC G06F 9/45558; G06F 3/0604; G06F 3/0664; G06F 3/0673; G06F 2009/45583

(57) ABSTRACT

Disclosed herein is a method for improving performance of a hypervisor in a memory disaggregation environment. The method includes allocating memory pages to a virtual machine in preset units, comparing the address range of the page frame to be returned with a preset page size, and removing an address space mapping for the page frame to be returned depending on a result of comparison with the preset page size. Removing the address space mapping comprises removing the address space mapping on the basis of contiguous page frames when the range of the page frame to be returned is equal to or greater than the preset page size.

### CROSS REFERENCE TO RELATED APPLICATIONS

This application claims the benefit of Korean Patent Applications No. 10-2023-0117380, filed Sep. 5, 2023, and No. 10-2023-0164357, filed Nov. 23, 2023,which are hereby incorporated by reference in their entireties into this application.

### BACKGROUND OF THE INVENTION

### 1. Technical Field

The present disclosure relates to technology for improving performance of a hypervisor in a disaggregated memory system.

More particularly, the present disclosure relates to technology for improving performance of a hypervisor through unit-based memory page reclamation and provision of information about reclaimed memory.

### 2. Description of the Related Art

These days, data centers offering cloud services are showing interest in providing resource disaggregation. The resource disaggregation is technology for efficiently using resources by sharing computing and memory resources of multiple computers. In particular, the recent increase in memory usage for training and inference of large-scale Artificial Intelligence (AI) language models leads to growing demand for memory disaggregation technology.

Data centers basically provide computing and memory resources to multiple users using virtualization technology and allocate resources on a per-virtual-machine basis. However, when a disaggregated memory system is applied, memory resources need to be finely segmented and managed even at a virtual-machine level, but this is not yet considered. For example, when a virtual machine is created, a hypervisor allocates a given memory region to the virtual machine and manages the same. The virtual machine generally uses the corresponding memory region without returning the same until it is terminated or migrated. However, when a disaggregated memory system is applied, frequently used memory pages are retained in host local memory but infrequently used memory pages are evicted to remote memory, and this leads to frequent memory page allocation/reclamation. Accordingly, memory pages need to be finely segmented and managed.

Such management becomes more complex when a virtual machine uses a Nested Page Table (NPT) and attempts to modify the physical memory thereof. This problem occurs because a hypervisor is not aware of the memory actually used by a virtual machine after it first allocates memory to the virtual machine. Balloon driver technology is helpful to solve a problem of memory view disparity between a virtual machine and a hypervisor. The balloon driver technology is a method in which, when a hypervisor requests a virtual machine to return memory, the virtual machine returns unnecessary memory pages of memory managed thereby to the hypervisor. However, because large-size memory is returned and because significant performance overhead is caused, it is difficult to apply this to a disaggregated memory system. Therefore, technology capable of solving these problems in a disaggregated memory system is required.

### DOCUMENTS OF RELATED ART

(Patent Document 1) Korean Patent Application Publication No. 2010-0012263, titled “Solid state storage system and controlling method thereof”.

### SUMMARY OF THE INVENTION

An object of the present disclosure is to improve performance of a virtualization system recognizing a disaggregated memory system.

Another object of the present disclosure is to increase the granularity of memory return from a virtual machine at a hypervisor level, thereby improving performance of a hypervisor.

A further object of the present disclosure is to provide a hint for memory to be returned, thereby improving performance of a hypervisor.

In order to accomplish the above objects, a method for improving performance of a hypervisor in a memory disaggregation environment according to an embodiment of the present disclosure includes allocating memory pages to a virtual machine in preset units, comparing the address range of a page frame to be returned with a preset page size, and removing an address space mapping for the page frame to be returned depending on a result of comparison with the preset page size. Removing the address space mapping comprises removing the address space mapping on the basis of contiguous page frames when the range of the page frame to be returned is equal to or greater than the preset page size.

Here, removing the address space mapping may comprise removing the address space mapping for each page frame when the range of the page frame to be returned is less than the preset page size.

Here, removing the address space mapping may comprise, when the address space mapping is removed for each page frame, removing the mapping of an address space mapped to the page frame based on a data structure in the form of a reverse map (rmap).

Here, allocating the memory pages to the virtual machine may comprise allocating physically contiguous memory pages in preset units.

Here, comparing the address range with the preset page size may include determining whether the address range of the page frame to be returned corresponds to contiguously allocated pages.

Here, removing the address space mapping may comprise removing the address space mapping using contiguously allocated head information of page table entry lists of the reverse map when the range of the page frame to be returned is equal to or greater than the preset page size.

Here, the method may further include, when a memory page in the virtual machine corresponds to a free page, delivering the virtual address of the memory page corresponding to the free page to a virtual machine tool module at a kernel level.

Here, delivering the virtual address to the virtual machine tool module at the kernel level may include delivering a physical address corresponding to the virtual address to the hypervisor and marking the physical address with a free page flag.

Here, when a page fault occurs for a page marked with the free page flag, an initialized page in local memory may be used.

Also, in order to accomplish the above objects, an apparatus for improving performance of a hypervisor in a memory disaggregation environment according to an embodiment of the present disclosure includes a memory allocation unit for allocating memory pages to a virtual machine in preset units and a memory return unit for comparing the address range of a page frame to be returned with a preset page size and removing an address space mapping for the page frame to be returned depending on a result of comparison with the preset page size. When the range of the page frame to be returned is equal to or greater than the preset page size, the memory return unit may remove the address space mapping on the basis of contiguous page frames.

Here, when the range of the page frame to be returned is less than the preset page size, the memory return unit may remove the address space mapping for each page frame.

Here, when the address space mapping is removed for each page frame, the memory return unit may remove the mapping of an address space mapped to the page frame based on a data structure in the form of a reverse map (rmap).

Here, the memory allocation unit may allocate physically contiguous memory pages in preset units.

Here, the memory return unit may determine whether the address range of the page frame to be returned corresponds to contiguously allocated pages.

Here, when the range of the page frame to be returned is equal to or greater than the preset page size, the memory return unit may remove the address space mapping using contiguously allocated head information of page table entry lists of the reverse map.

Here, when a memory page in the virtual machine corresponds to a free page, the memory return unit may deliver the virtual address of the memory page corresponding to the free page to a virtual machine tool module at a kernel level.

Here, the memory return unit may deliver a physical address corresponding to the virtual address to the hypervisor and mark the physical address with a free page flag.

Also, in order to accomplish the above objects, a method for improving performance of a hypervisor in a memory disaggregation environment according to an embodiment of the present disclosure includes allocating memory pages to a virtual machine in preset units, delivering, when a memory page in the virtual machine corresponds to a free page, the virtual address of the memory page corresponding to the free page to a virtual machine tool module at a kernel level, and delivering a physical address corresponding to the virtual address to the hypervisor.

Here, the method may further include marking the physical address with a free page flag.

Here, when a page fault occurs for a page marked with the free page flag, an initialized page in local memory may be used.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for improving performance of a hypervisor in a memory disaggregation environment according to an embodiment of the present disclosure;

FIG. 2 is a flowchart illustrating a method for improving performance of a hypervisor in a memory disaggregation environment according to another embodiment of the present disclosure;

FIG. 3 conceptually illustrates a process of traversing a reverse map (rmap) and removing address space mappings for the return of memory pages;

FIG. 4 conceptually illustrates a unit-based initialization method for an rmap in a batched-unmap technique;

FIG. 5 is a flowchart illustrating a batched-unmap technique according to an embodiment of the present disclosure;

FIG. 6 is a view conceptually illustrating a method of performing a function of providing a hint for free pages;

FIG. 7 is a graph illustrating system performance when technology for improving performance of a hypervisor according to an embodiment of the present disclosure is applied;

FIG. 8 is a block diagram illustrating an apparatus for improving performance of a hypervisor in a memory disaggregation environment according to an embodiment of the present disclosure; and

FIG. 9 is a view illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

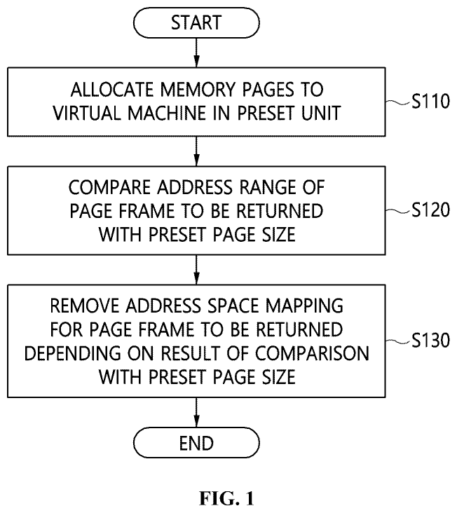

FIG. 1 is a flowchart illustrating a method for improving performance of a hypervisor in a memory disaggregation environment according to an embodiment of the present disclosure.

The method for improving performance of a hypervisor in a memory disaggregation environment according to an embodiment of the present disclosure may be performed by an apparatus for hypervisor performance improvement, such as a computing device, a server, or the like.

Referring to FIG. 1, the method for improving performance of a hypervisor in a memory disaggregation environment according to an embodiment of the present disclosure includes allocating memory pages to a virtual machine in preset units at step S110, comparing the address range of the page frame to be returned with a preset page size at step S120, and removing an address space mapping for the page frame to be returned depending on a result of comparison with the preset page size at step S130. Removing the address space mapping comprises removing the address space mapping on the basis of contiguous page frames when the range of the page frame to be returned is equal to or greater than the preset page size.

Here, removing the address space mapping at step S130 may comprise removing the address space mapping for each page frame when the range of the page frame to be returned is less than the preset page size.

Here, removing the address space mapping at step S130 may comprise, when the address space mapping is removed for each page frame, removing the mapping of the address space mapped to the page frame based on a data structure in the form of a reverse map (rmap).

Here, allocating the memory pages to the virtual machine in preset units at step S110 may comprise allocating physically contiguous memory pages in preset units.

Here, comparing the address range with the preset page size at step S120 may include determining whether the address range of the page frame to be returned corresponds to contiguously allocated pages.

Here, removing the address space mapping at step S130 may comprise removing the address space mapping using contiguously allocated head information of page table entry lists of the reverse map when the address range of the page frame to be returned is equal to or greater than the preset page size.

Here, the method may further include, when a memory page in the virtual machine corresponds to a free page, delivering the virtual address of the memory page corresponding to the free page to a virtual machine tool module at a kernel level.

Here, delivering the virtual address to the virtual machine tool module at the kernel level may include delivering a physical address corresponding to the virtual address to the hypervisor and marking the physical address with a free page flag.

Here, in the method, an initialized page in local memory may be used when a page fault occurs for a page marked with the free page flag.

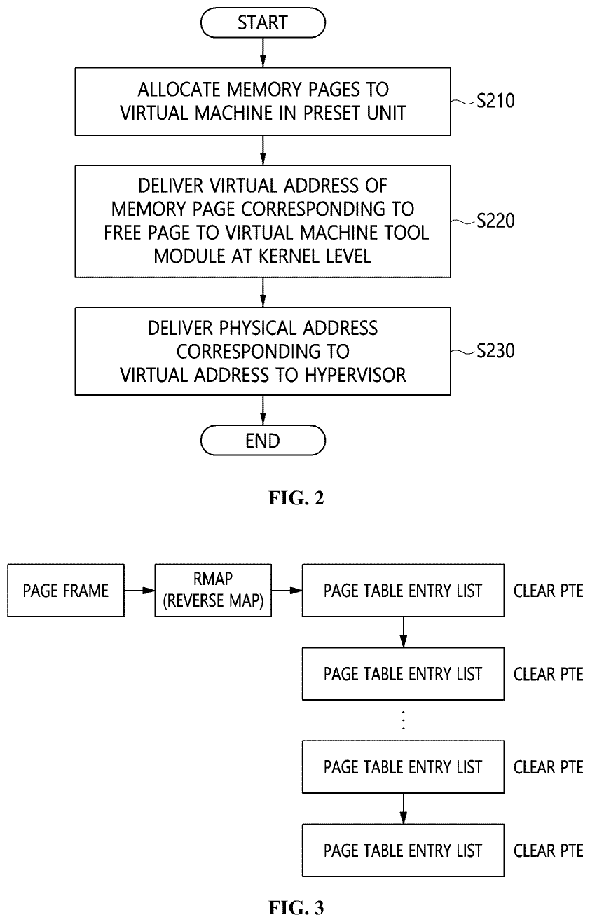

FIG. 2 is a flowchart illustrating a method for improving performance of a hypervisor in a memory disaggregation environment according to another embodiment of the present disclosure.

The method for improving performance of a hypervisor in a memory disaggregation environment according to an embodiment of the present disclosure may be performed by an apparatus for hypervisor performance improvement, such as a computing device, a server, or the like.

Referring to FIG. 2, the method for improving performance of a hypervisor in a memory disaggregation environment according to an embodiment of the present disclosure includes allocating memory pages to a virtual machine in preset units at step S210, delivering, when a memory page in the virtual machine corresponds to a free page, the virtual address of the memory page corresponding to the free page to a virtual machine tool module at a kernel level at step S220, and delivering a physical address corresponding to the virtual address to the hypervisor at step S230.

Here, the method may further include marking the physical address with a free page flag.

Here, in the method, an initialized page in local memory may be used when a page fault occurs in the marked page.

Hereinafter, embodiments of the present disclosure will be described in detail with reference to FIGS. 3 to 6.

FIG. 3 conceptually illustrates a process of traversing a reverse map (rmap) and removing address space mappings for the return of memory pages.

In a virtualization system, a hypervisor allocates large memory when it first creates a virtual machine, and the virtual machine is able to use the memory without returning the same until the virtual machine is terminated or migrated. Accordingly, there is no need to consider performance for a memory return mechanism. However, because a disaggregated memory system is configured to retain frequently used memory in local memory and to evict infrequently used memory to remote memory, allocation and reclamation of memory and modification of a process address space may frequently occur.

When a memory page needs to be migrated to remote memory, the hypervisor may use a method of removing the mapping of the corresponding page to a virtual machine process address space and transferring the data to the remote memory. Because a single page may be mapped to another address space through page sharing, an Operating System (OS) may create a data structure called a reverse map (rmap) and index the address spaces to which the single page is mapped, as shown in FIG. 3.

Accordingly, in order to return a single page, a mapping in each address space is removed while traversing the reverse map (rmap). However, because the address space can be modified by a process of the virtual machine even in the virtual machine, removing the mapping may be performed after locking the address space.

Because returning a memory page as described above requires a task of traversing the reverse map (rmap) and clearing the page table entry of each address space, a large overhead may be caused. The existing virtualization system returns memory pages only when a virtual machine is migrated or terminated, but when a disaggregated memory system is applied, the return of memory pages may frequently occur while the virtual machine is running, so performance improvement therefor may be required. Therefore, the present disclosure enables memory to be quickly returned by increasing the granularity of memory return from a virtual machine, thereby improving performance of a hypervisor in a memory disaggregation environment.

The problems with the above-described memory page return are that tracing a large number of pointers is required because the list is traversed through the reverse map (rmap) and that the address space cannot be modified when a virtual machine or a host accesses the address space because it is necessary to lock the address space.

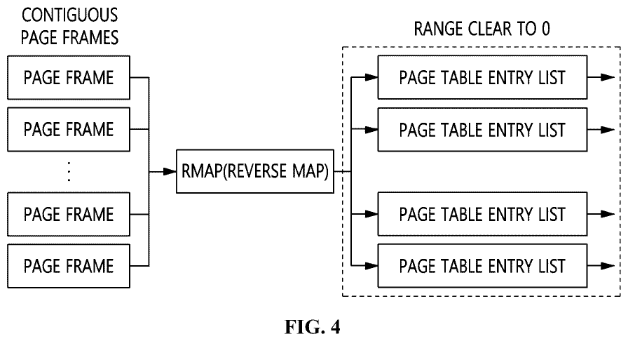

FIG. 4 conceptually illustrates a unit-based initialization method for an rmap of a batched-unmap technique.

The present disclosure allocates memory pages of a virtual machine in physically contiguous units and uses a method of clearing a region for contiguous page frames, as shown in FIG. 4, and this method is referred to as ‘Batched Unmap’ and proposed.

When contiguously allocated page frames are returned, because heads for page table entry lists of the rmap are contiguously allocated, a method of initializing this range may be used. This is a technique that can be used for physically contiguous page frames, but because a disaggregated memory system typically uses prefetching in order to preserve spatial locality, allocating contiguous pages may be helpful in performance improvement. Therefore, the batched unmap technique proposed by the present disclosure may be well utilized in the disaggregated memory system. Also, when pages are not contiguously allocated, the existing rmap traversing technique can be used, so returning pages is not erroneously performed.

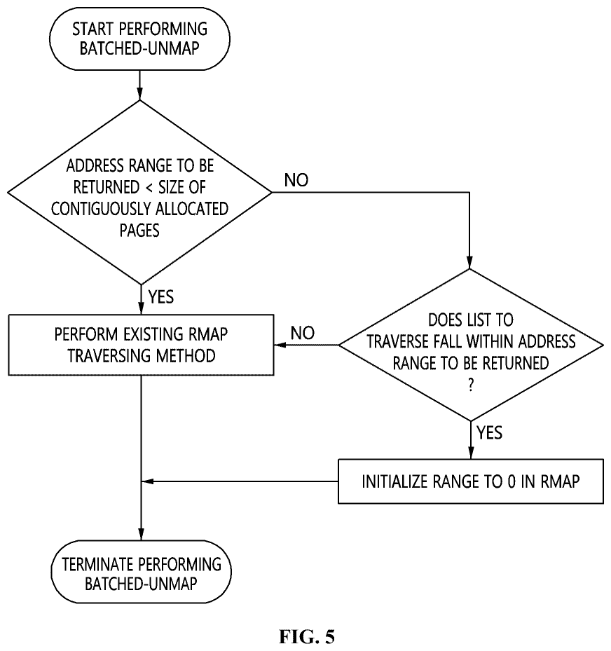

FIG. 5 is a flowchart illustrating a batched-unmap technique according to an embodiment of the present disclosure.

When memory pages need to be returned because they are selected as infrequently used pages in a disaggregated memory system, a page with a large allocation granularity is returned, and a batched unmap process may be performed in order to return the page. First, whether the range of the address to be returned corresponds to contiguously allocated pages is checked. This is the step of determining whether the range corresponds to memory pages to which batched unmap can be applied, and when the range is less than the size of contiguously allocated pages, the memory pages are discontinuous pages, and the existing rmap traversing method may be performed. Also, even though the range corresponds to contiguously allocated pages to which batched unmap can be applied, when the list to traverse is not present, the existing method is performed. Accordingly, the rmap range of the pages to which batched unmap can be applied is selected, and the range is initialized to 0, whereby batched unmap is performed.

Hereinbelow, technology for providing agreement on a memory view between a hypervisor and a virtual machine on a virtualization system in a memory disaggregation environment will be described. In the virtualization system, after a hypervisor allocates memory when it creates a virtual machine, the hypervisor has no method of determining the context on the corresponding memory. That is, there is no method for determining whether the virtual machine is using the memory allocated thereto or whether the memory page is used or not. The absence of such information causes inefficiency in the disaggregated memory system.

For example, a memory page allocated to a virtual machine may not be allocated by any process in the virtual machine, but a hypervisor does not know such information. Therefore, when the current hypervisor intends to reclaim the corresponding memory page from the virtual machine in the disaggregated memory system environment, data on the corresponding memory page has to be separately stored before being reclaimed. That is, after a page is evicted to remote memory because it is not frequently used in the virtual machine, when the page is freed by a process in the virtual machine, the page is a free page. Therefore, even though the page is accessed again, there is no need to bring the page to local memory because it is a free page, but access to the page requires fetching the page from the remote memory and storing the same.

A function of providing a hint for a free page (Free Page Awareness (FPA)) according to an embodiment of the present disclosure may solve the above problem through a function of delivering information about such a free page to the hypervisor. If a memory page is a free page in a virtual machine, when it is evicted to remote memory by a hypervisor of a disaggregated memory system, there is no need to retain the data of the page, and when data in use is evicted to remote memory by the disaggregated memory system and becomes a free page, there is no need to retain the data of the page.

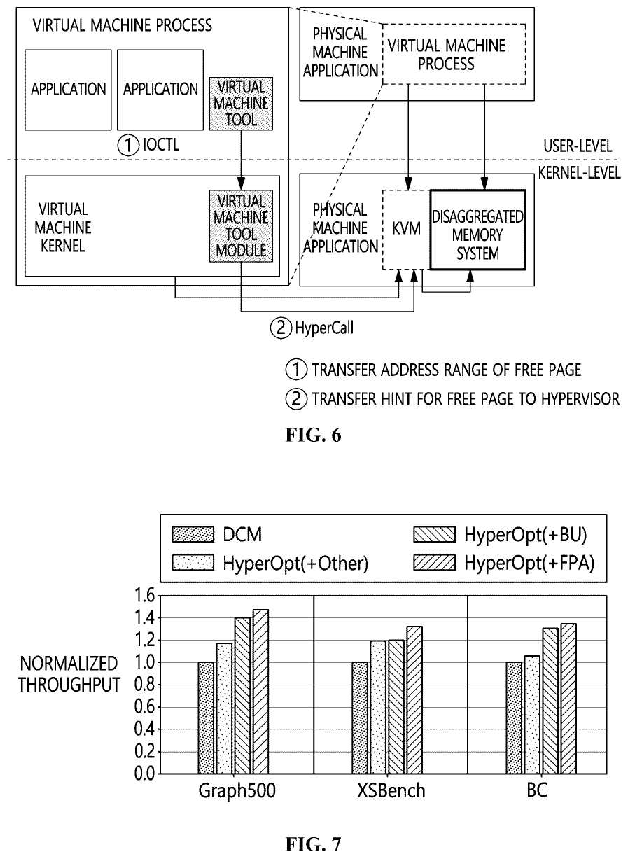

FIG. 6 is a view conceptually illustrating a process of performing a function of providing a hint for a free page (free page awareness).

In order to provide a hint for a free page, the help of an application and a kernel module in a virtual machine is required. Although the application can be modified, the present disclosure does not modify the application but creates a virtual machine tool at a user level and transfers the virtual addresses of free pages (guest virtual addresses) to a virtual machine tool module. The virtual machine tool module is a Loadable Kernel Module (LKM) that generates guest physical addresses depending on the virtual addresses of the free pages and delivers the hint for the free pages to a hypervisor in the form of a hypercall, and the hypervisor may recognize the free pages by receiving the parameter of the hypercall and use a method of marking a free page flag for the pages.

In the case of a page marked with the free page flag, even when a page fault occurs for the page, it is not fetched from remote memory, and an initialized page in local memory is used. Accordingly, the number of accesses to the remote memory may be reduced.

FIG. 7 is a graph illustrating the performance of a system when technology for improving performance of a hypervisor according to an embodiment of the present disclosure is applied.

Referring to FIG. 7, the graph shows data loading performance when Graph500, XSBench, and BC benchmark are run in a disaggregated memory system. In the graph, the data loading performance is normalized to performance acquired when Disaggregated Cloud Memory with Elastic Block Management (DCM) is used, and the result acquired when the size of host local memory is fixed to 30% of the total amount of memory used by each benchmark is displayed. The result shows that, when a performance optimization technique other than batched unmap (+BU) is used, an average of 29.7% performance improvement is achieved compared to DCM, and applying batched unmap results in an average of 14% performance improvement compared to when the performance optimization technique other than batched unmap is applied. Also, it can be seen that an average of 5.5% performance improvement is further achieved when the function of providing a hint for free pages (free page awareness (+FPA)) is used.

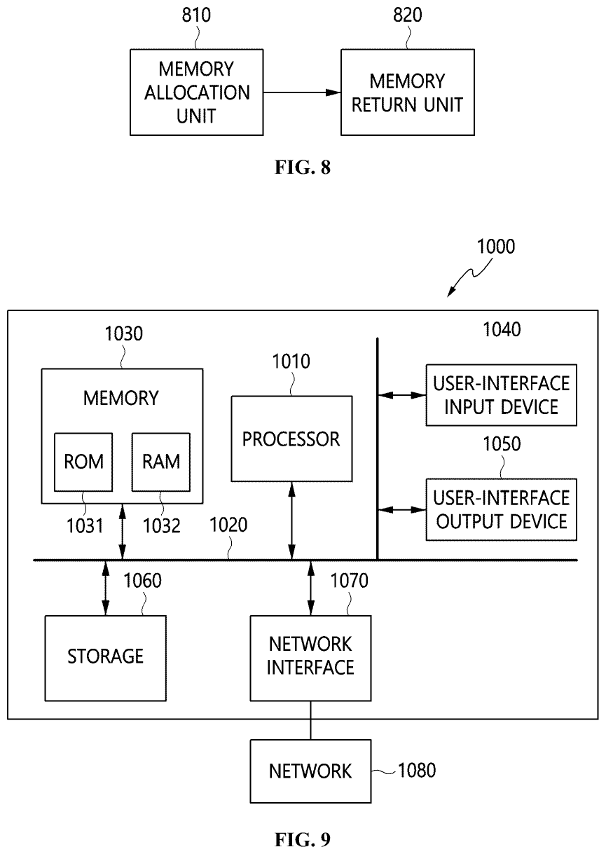

FIG. 8 is a block diagram illustrating an apparatus for improving performance of a hypervisor in a memory disaggregation environment according to an embodiment of the present disclosure.

Referring to FIG. 8, the apparatus for improving performance of a hypervisor in a memory disaggregation environment according to an embodiment of the present disclosure includes a memory allocation unit 810 for allocating memory pages to a virtual machine in preset units and a memory return unit 820 for comparing the address range of the page frame to be returned with a preset page size and removing an address space mapping for the page frame to be returned depending on a result of comparison with the preset page size. The memory return unit removes the address space mapping on the basis of contiguous page frames when the range of the page frame to be returned is equal to or greater than the preset page size.

Here, when the range of the page frame to be returned is less than the preset page size, the memory return unit 820 may remove the address space mapping for each page frame.

Here, when it removes the address space mapping for each page frame, the memory return unit 820 may remove the mapping of the address space mapped to the page frame based on a data structure in the form of a reverse map (rmap).

Here, the memory allocation unit 810 may allocate physically contiguous memory pages in preset units.

Here, the memory return unit 820 may determine whether the address range of the page frame to be returned corresponds to contiguously allocated pages.

Here, when the range of the page frame to be returned is equal to or greater than the preset page size, the memory return unit 820 may remove the address space mapping using contiguously allocated head information of page table entry lists of the reverse map.

Here, when a memory page in the virtual memory corresponds to a free page, the memory return unit 820 may deliver the virtual address of the memory page corresponding to the free page to a virtual machine tool module at a kernel level.

Here, the memory return unit 820 may deliver a physical address corresponding to the virtual address to a hypervisor and mark the physical address with a free page flag.

FIG. 9 is a view illustrating the configuration of a computer system according to an embodiment.

The apparatus for improving performance of a hypervisor in a memory disaggregation environment according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the present disclosure, performance of a virtualization system recognizing a disaggregated memory system may be improved.

Also, the present disclosure may increase the granularity of memory return from a virtual machine at a hypervisor level, thereby improving performance of a hypervisor.

Also, the present disclosure provides a hint for memory to be returned, thereby improving performance of a hypervisor.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for improving performance of a hypervisor in a memory disaggregation environment, comprising:
allocating memory pages to a virtual machine in preset units;
comparing an address range of a page frame to be returned with a preset page size; and
removing an address space mapping for the page frame to be returned depending on a result of comparison with the preset page size,
wherein removing the address space mapping comprises removing the address space mapping on a basis of contiguous page frames when the range of the page frame to be returned is equal to or greater than the preset page size.

2. The method of claim 1, wherein removing the address space mapping comprises removing the address space mapping for each page frame when the range of the page frame to be returned is less than the preset page size.

3. The method of claim 2, wherein removing the address space mapping comprises, when the address space mapping is removed for each page frame, removing a mapping of an address space mapped to the page frame based on a data structure in a form of a reverse map.

4. The method of claim 2, wherein allocating the memory pages to the virtual machine comprises allocating physically contiguous memory pages in preset units.

5. The method of claim 2, wherein comparing the address range with the preset page size includes determining whether the address range of the page frame to be returned corresponds to contiguously allocated pages.

6. The method of claim 3, wherein removing the address space mapping comprises removing the address space mapping using contiguously allocated head information of page table entry lists of the reverse map when the range of the page frame to be returned is equal to or greater than the preset page size.

7. The method of claim 1, further comprising:
when a memory page in the virtual machine corresponds to a free page, delivering a virtual address of the memory page corresponding to the free page to a virtual machine tool module at a kernel level.

8. The method of claim 7, wherein delivering the virtual address to the virtual machine tool module at the kernel level includes
delivering a physical address corresponding to the virtual address to the hypervisor; and
marking the physical address with a free page flag.

9. The method of claim 8, wherein, when a page fault occurs for a page marked with the free page flag, an initialized page in local memory is used.

10. An apparatus for improving performance of a hypervisor in a memory disaggregation environment, comprising:
a memory allocation unit for allocating memory pages to a virtual machine in preset units; and
a memory return unit for comparing an address range of a page frame to be returned with a preset page size and removing an address space mapping for the page frame to be returned depending on a result of comparison with the preset page size,
wherein the memory return unit removes the address space mapping on a basis of contiguous page frames when the range of the page frame to be returned is equal to or greater than the preset page size.

11. The apparatus of claim 10, wherein, when the range of the page frame to be returned is less than the preset page size, the memory return unit removes the address space mapping for each page frame.

12. The apparatus of claim 11, wherein, when the address space mapping is removed for each page frame, the memory return unit removes a mapping of an address space mapped to the page frame based on a data structure in a form of a reverse map.

13. The apparatus of claim 11, wherein the memory allocation unit allocates physically contiguous memory pages in preset units.

14. The apparatus of claim 11, wherein the memory return unit determines whether the address range of the page frame to be returned corresponds to contiguously allocated pages.

15. The apparatus of claim 12, wherein, when the range of the page frame to be returned is equal to or greater than the preset page size, the memory return unit removes the address space mapping using contiguously allocated head information of page table entry lists of the reverse map.

16. The apparatus of claim 10, wherein, when a memory page in the virtual machine corresponds to a free page, the memory return unit delivers a virtual address of the memory page corresponding to the free page to a virtual machine tool module at a kernel level.

17. The apparatus of claim 16, wherein the memory return unit delivers a physical address corresponding to the virtual address to the hypervisor and marks the physical address with a free page flag.

18. A method for improving performance of a hypervisor in a memory disaggregation environment, comprising:
allocating memory pages to a virtual machine in preset units;
when a memory page in the virtual machine corresponds to a free page, delivering a virtual address of the memory page corresponding to the free page to a virtual machine tool module at a kernel level; and
delivering a physical address corresponding to the virtual address to the hypervisor.

19. The method of claim 18, further comprising:
marking the physical address with a free page flag.

20. The method of claim 19, wherein, when a page fault occurs for a page marked with the free page flag, an initialized page in local memory is used.
